(19) United States
(12) Patent Application Publication
(10) Pub. No.: US 2003/0149807 A1
(43) Pub. Date: Aug. 7, 2003

(54) Transmission management device of a high-density information processing system

(76) Inventor: Chun-Liang Lee, Taipei (TW)

Correspondence Address: BIRCH STEWART KOLASCH & BIRCH, PO BOX 747, FALLS CHURCH, VA, 22040-0747, US

(21) Appl. No.: 10/062,480

(22) Filed: Feb. 5, 2002

(51) Int. Cl. G06F 3/00

(52) U.S. Cl. 710/5

(57) ABSTRACT

A transmission management device of a high-density information processing system, which utilizes a bus and a serial port RS485 to manage the high-density information processing system and to transmit information. The transmission management device includes a transmission system and a control system. The transmission system is used for communicating with independent sub-systems of the high-density information processing system and for transmitting information. The control system is used for receiving information from an external system and for directly communicating with the transmission system. The invention achieves the objectives of information transmission in a high-density information processing system and management of independent sub-systems.

### BACKGROUND OF THE INVENTION

1.Field of the Invention

The invention relates to a transmission management device, and more particularly, to a transmission management device of a high-density information processing system.

2.Related Art

A server in a network system provides a variety of services for different terminals, such as databases, file storage, printers, email, web pages, and so on. In order to provide the above services for multiple terminals, the server needs to have the ability of processing and making responses to all requests and information transmitted from the multiple terminals simultaneously. In regards to hardware, multiple I/O ports have to be installed at the server to receive the information transmitted from the multiple terminals. As far as software goes, the server must be capable of managing the information transmitted from the multiple terminals.

Since the server has to service multiple terminals, many independent sub-systems are installed in a high-density information processing system. Transmitting data and commands among the conventional high-density information processing system and the independent sub-systems or a distant system relies only on an 12C bus. However, using only the 12C bus to manage the complete high-density information processing system often causes the problems of information delays and inefficiency.

In summary, the high-density information processing system managed by the 12C bus is inefficient and takes a long time to manage. Therefore, how to efficiently transmit data and commands to achieve the objective of managing a high-density information processing system is an important technical issue to be solved.

### SUMMARY OF THE INVENTION

In the view of the foregoing, the invention provides a transmission management device of a high-density information processing system with the objective of increasing the efficiency of transmitting information and managing independent sub-systems.

The disclosed transmission management device of a high-density information processing system includes a transmission system and a control system. The transmission system is used for connecting independent sub-systems in the high-density information processing system and for transmitting data. The control system is used for receiving data from an external system and for communicating with a transmission system directly, to achieve the objective of transmitting data and managing the independent sub-systems by the high-density information processing system.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a system block diagram of the disclosed transmission management device of a high-density information processing system;

FIG. 2 is a block diagram of the transmission system in FIG. 1; and

FIG. 3 is a block diagram of the control system in FIG. 1.

### DETAILED DESCRIPTION OF THE INVENTION

The invention discloses a transmission management device of a high-density information processing system. The invention utilizes a serial port RS485 and an 12C bus to manage the server and to transmit data.

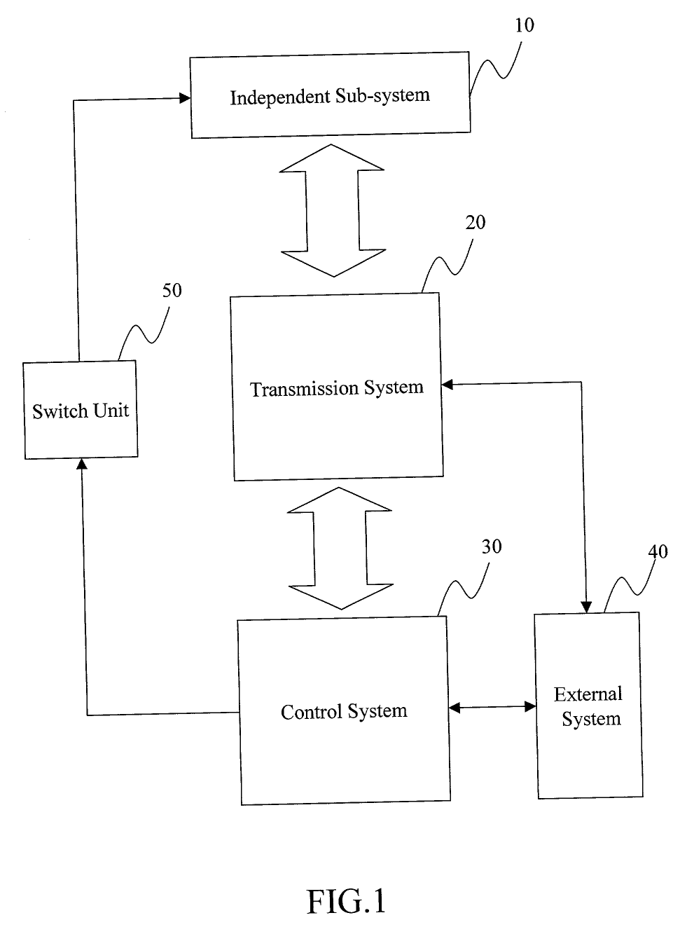

As shown in FIG. 1, the disclosed transmission management device of a high-density information processing system includes: a transmission system 20 and a control system 30. The transmission system 20 connected with independent sub-systems 10 of the high-density information processing system is used for receiving and storing data and commands of the high-density information processing system and an external system, and for transmitting the information and the commands to the independent sub-system 10 through the serial port RS485 . The control system 30 connected with the transmission system 20 is used for receiving the information and the commands from the external system 40 and for transmitting the information and the commands to the transmission system 20 and to the independent sub-systems 10 through the 12C bus.

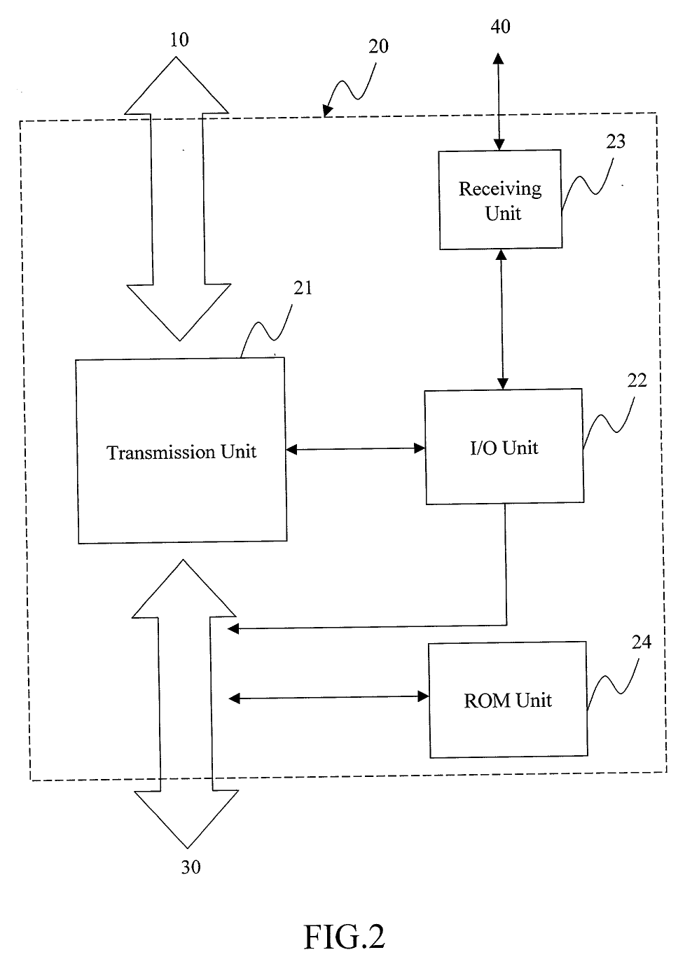

A detailed illustration of the transmission system 20 of the invention is provided in FIG. 2.

The transmission system 20 of the invention includes a transmitting unit 21, an I/O unit 22, a receiving unit 23 and a ROM unit 24. The transmitting unit 21 is a serial port RS485 connecting device for communication with the independent sub-systems 10 and transmission of information and commands from the high-density information processing system and the external system 40. A data bus installed between the transmission system and the control system 30 is used for direct data transmission and communication. The receiving unit 23, which is a serial port RS485 connecting device, connects to the external system 40. The I/O unit 22, which is a super I/O, connects to the receiving unit 23 for receiving the information and commands of the external system 40 and for transmitting the information and commands to the transmitting unit 21 and the control system 30 through a data bus. The ROM unit 24 is ROM (Read Only Memory) connected with the data bus for storing the data and commands of the high-density information processing system.

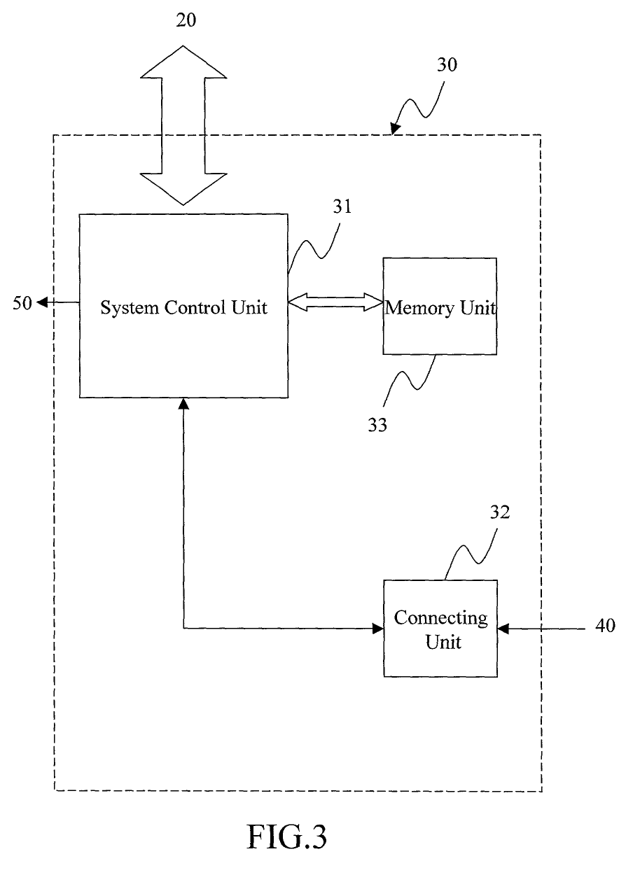

A detailed illustration of the control system 30 of the invention is provided in FIG. 3.

The control system 30 includes a system control unit 31, a connecting unit 32 and a memory unit 33. The system control unit 31 is a SOC (System On Chip). The SOC, containing a processor, a memory controller and an interface controller, is used for transmitting the information, the commands and the interrupt signals of the external system 40 to the transmission system 20 and the independent sub-systems 10 through the 12C bus. An 12C bus switch unit 50 in the 12C bus is used for switching the signals of the 12C bus and for transmitting the signals to the different independent sub-systems 10. The connecting unit 32 receives the information and the commands of the external system 40 and transmits the information and the commands to the system control unit 31. The memory unit 33 is SDRAM ( Synchronous Dynamic Random Access Memory ) connected with the system control unit 31 for storing the information and commands of the external system 40.

A peripheral component is installed between the connecting unit 32 and the system control unit 31 to connect with the PCI bus. A memory bus is further installed between the system control unit 31 and the memory unit 33 for transmitting data.

In summary, the invention utilizes a serial port RS458 and a bus to manage the server and to transmit information. The advantage is that the invention can not only improve management efficiency but also increase the speed of data transmission.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transmission management device of a high-density information processing system installed with a serial port RS485 and a bus, the transmission management device comprising:
a transmission system connected with an independent sub-system of the high-density information processing system for receiving data and commands from the high-density information processing system and an external system, and for transmitting the data and the commands of the high-density information processing system and the external system to the independent sub-system via the serial port RS485; and
a control system connected with the transmission system for receiving the data and the commands from the high-density information processing system and the external system and passing the information and the commands onto the transmission system, and to the independent sub-system through the bus.

2. The transmission management device of claim 1, wherein the transmission system comprises:
a transmission unit connected with the independent sub-system for communicating with the independent sub-system and transmitting the data and commands of the high-density information processing system;
a receiving unit for connecting to the external system;
an I/O unit connected with the receiving unit for receiving the data and commands of the external system and for transmitting the data and commands to the transmission system and the control system; and
a ROM (Read Only Memory) unit connected with the data bus for storing the data and commands of the high-density information processing system.

3. The transmission management device of claim 2, wherein the transmission unit is a serial port RS485 connecting device.

4. The transmission management device of claim 2, wherein the receiving unit is a serial port RS485 connecting device.

5. The transmission management device of claim 2, wherein the I/O unit is a super I/O.

6. The transmission management device of claim 2, wherein the ROM unit is a ROM.

7. The transmission management device of claim 1, wherein the control system comprises:
a connecting unit connected with the external system;
a system control unit connected with the connecting unit for transmitting the data and the commands of the external system and for transmitting the data and the commands to the transmission system and to the independent sub-system through the bus;
a memory unit connected with the system control unit for storing the data and the commands of the external system.

8. The transmission management device of claim 7, wherein the system control unit is a SOC (System On Chip).

9. The transmission management device of claim 7, wherein the memory unit is SDRAM.

10. The transmission management device of claim 7, wherein a PCI Bus is installed between the connecting unit and the system control unit.

11. The transmission management device of claim 7, wherein a memory bus is installed between the control unit and the memory unit.

12. The transmission management device of claim 1, wherein a data bus is installed between the transmission system and the control system.

13. The transmission management device of claim 1, wherein the bus is an I2C bus.

14. The transmission management device of claim 13, wherein the bus contains an I2C bus-switching device for switching the bus signals, thereby transmitting the signals to the different independent sub-systems.

15. The transmission management device of claim 13, wherein the high-density information processing system is a server.
